(19) United States
(12) Patent Application Publication
(10) Pub. No.: US 2010/0260188 A1
(43) Pub. Date: Oct. 14, 2010

(54) METHOD AND DEVICE FOR PROCESSING QINQ PACKET

(76) Inventor: Dongchen Zhou, Shenzhen (CN)

Correspondence Address: Huawei/BHGL, P.O. Box 10395, Chicago, IL, 60610, US

(21) Appl. No.: 12/757,735

(22) Filed: Apr. 9, 2010

(30) Foreign Application Priority Data
Apr. 10, 2009 (CN) 200910131625.0

(51) Int. Cl. H04L 12/28

(52) U.S. Cl. 370/395.53

(57) ABSTRACT

In the field of network communications, an 802.1Q in 802.1Q (QinQ) packet processing method and a QinQ packet processing device are provided. The processing method includes: generating a keyword according to at least a virtual local area network (VLAN) identification (VLAN ID) of a QinQ packet; matching the keyword with prefix-mask in a QinQ access table to obtain a matching entry in the QinQ access table; and processing the QinQ packet according to control information of the matching entry. Through the QinQ packet processing method and device, VLAN ID ranges requiring to occupy multiple QinQ access table entries in the prior art are aggregated into one QinQ access table entry through aggregation, so as to expand the number of VLAN ID users actually supported by a QinQ access table and save valuable entry resources of the QinQ access table.

### CROSS-REFERENCE TO RELATED APPLICATION

This application claims priority to Chinese Patent Application No. 200910131625.0, filed on Apr. 10, 2009, which is hereby incorporated by reference in its entirety.

### FIELD OF THE TECHNOLOGY

The present invention relates to the field of network communications, and more particularly to a method and device for processing 802.1Q in 802.1Q (QinQ) packet.

### BACKGROUND OF THE INVENTION

With the large-scale deployment of the Ethernet technology in an operator network, the isolation and identification of users using an 802.1Q virtual local area network (VLAN) are greatly limited. Because a VLAN identification (ID) domain defined in the Institute for Electrical and Electronic Engineers (IEEE) 802.1Q is of only 12 bits and capable of representing merely 4096 (4K) VLANs, which is not enough to cope with a large number of users required to be identified in a metropolitan Ethernet, the QinQ technology emerges accordingly.

The QinQ protocol is a Layer 2 Tunneling Protocol (L2TP) based on the IEEE 802.1Q technology and is a technology for expanding the VLAN space. Specifically, the QinQ protocol expands the VLAN space by adding one layer of 802.1Q tag headers on the basis of an 802.1Q tag packet, so as to realize transparent transmission of a private network VLAN to a public network. Because a packet transferred based on such a technology in a backbone network has two layers of 802.1Q TAG headers, that is, one layer of public network tags (namely, external tags) and one layer of private network tags (namely, internal tags), the technical protocol is referred to as the QinQ protocol, that is, 802.1Q-in-802.1Q protocol.

FIG. 1 shows a format of a QinQ packet. As shown in FIG. 1, the QinQ packet includes a destination media access control (MAC) address (DA), a source MAC address (SA), an external VLAN tag, an internal VLAN tag, and a type-length (TYPE-LEN). The external VLAN tag includes a 2-byte ETYPE field and a 2-byte TAG field. The TAG field further includes a priority, a canonical format indicator (CFI), and a VLAN ID domain. The VLAN ID is of 12 bits and capable of representing 4K VLANs. The format of the internal VLAN tag is the same as that of the external VLAN tag.

Through the QinQ technology, the operator network can provide one VLAN ID for different VLANs from the same user network, which saves VLAN IDs of the operator and solves the problem of increasing shortage of VLAN ID resources of the operator network.

FIG. 2 is a schematic structural view of a network based on the QinQ protocol. As shown in FIG. 2, user customer edge (CE) VLANs 100-200 (that is, the range of the VLAN IDs may be 100 to 200) on a switch 1 are connected in from a user side, and a provider edge (PE) VLAN 1000 is added to a network side egress. A QinQ packet carries two layers of VLAN IDs (the external VLAN ID 1000 and the internal VLAN IDs 100-200) when entering a router 1. The router 1 searches a QinQ access table precisely according to the information, determines whether the QinQ packet is a legal packet, and acquires information required for subsequent forwarding of the QinQ packet. In some applications, the router 1 may also search the QinQ access table according to port information and VLAN ID information and perform subsequent forwarding.

In such a situation that user VLAN IDs belong to a range, a VLAN ID range may be configured on the router 1, so that the user plans a VLAN ID used by the user within the configured range without considering whether the selected VLAN ID conflicts with the PE VLAN ID of the operator.

However, the following problem exists in the prior art. When VLAN IDs are configured for the user, internal VLAN IDs and external VLAN IDs may both belong to a range. In this case, the number of all possible combinations of port numbers, the external VLAN IDs, and the internal VLAN IDs is too great (which is the number of ports×4K×4K), and it is difficult for the QinQ access table to support such a large number. As a result, the QinQ access table cannot allocate all possibly combined entries to each port, thereby limiting the number of VLAN IDs configured for the user.

### SUMMARY OF THE INVENTION

In order to solve the problem that the number of VLAN IDs configured for the user is limited in the prior art, an embodiment of the present invention provides a method for processing QinQ packet. The method includes the following steps:

A keyword is generated according to at least a VLAN ID of a QinQ packet. The keyword is matched with a prefix-mask in a QinQ access table to obtain a matching entry in the QinQ access table. Control information in the QinQ access table is obtained according to the matching entry. The QinQ packet is processed according to the control information.

In another embodiment, the present invention provides a device for processing QinQ packet, which includes a keyword generating module, an entry matching module, and a packet operation module.

The keyword generating module is adapted to receive a QinQ packet, generate a keyword according to at least a VLAN ID of the QinQ packet, and send the keyword. The entry matching module is adapted to receive the keyword from the keyword generating module, match the keyword with a prefix-mask in a QinQ access table to obtain a matching entry in the QinQ access table, obtain control information according to the matching entry, and send the control information. The packet operation module is adapted to receive the control information from the entry matching module and process the received QinQ packet according to the control information.

Through the method and device provided in the embodiments of the present invention, because VLAN IDs are aggregated, entries in an access table are reduced, and the VLAN ID range supported by the QinQ access table is actually expanded.

### BRIEF DESCRIPTION OF THE DRAWINGS

FIG. 1 is a view illustrating a format of a QinQ packet;

FIG. 2 is a schematic structural view of a network based on the QinQ protocol;

FIG. 3 is a flow chart of a method for processing QinQ packet according to an embodiment of the present invention;

FIG. 4 is a flow chart of a method for processing QinQ packet according to another embodiment of the present invention;

FIG. 5 is a structural view of a device for processing QinQ packet according to an embodiment of the present invention;

FIG. 6 is a structural view of a device for processing QinQ packet according to another embodiment of the present invention;

FIG. 7 is a schematic structural view of a chip for longest prefix matching;

FIG. 8 is a structural view of a device for processing QinQ packet according to a further embodiment of the present invention; and

FIG. 9 is a structural view of a device for processing QinQ packet according to a still further embodiment of the present invention.

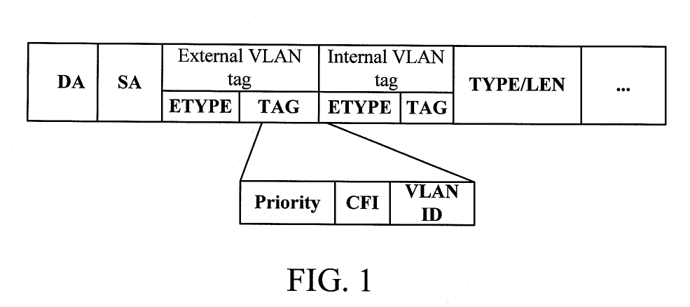

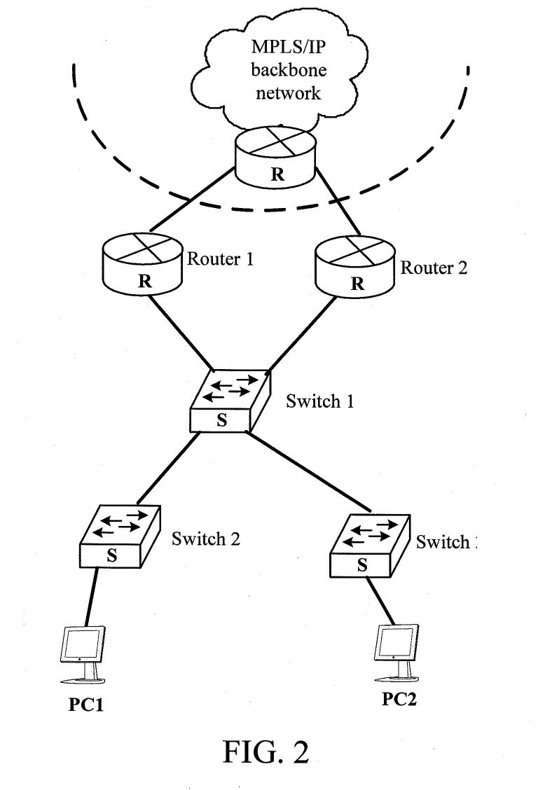

### DETAILED DESCRIPTION OF THE EMBODIMENTS

The embodiments of the present invention are described below more comprehensively with reference to the accompanying drawings, in which exemplary embodiments of the present invention are illustrated.

In the embodiments of the present invention, VLAN ID ranges of the same attribute are categorized into one or more prefixes-masks using prefix-mask aggregation. Through such aggregation, VLAN ID ranges requiring to occupy multiple QinQ access table entries in the prior art can be aggregated into one QinQ access table entry, so as to expand the number of VLAN ID users actually supported by a QinQ access table.

In the embodiments of the present invention, each entry in the QinQ access table includes a prefix-mask as a primary key and corresponding control information. The prefix-mask is configured or automatically generated according to a VLAN ID range. The specific implementation of generating a prefix-mask according to a VLAN ID range is introduced below. The control information includes forwarding information required for forwarding a QinQ packet or termination information required for terminating the QinQ packet. For example, the forwarding information includes information about Layer 2 forwarding, multi -protocol label switching (MPLS) forwarding, and Layer 3 forwarding, and the termination information includes information about single-layer or dual-layer termination, and a terminated VLAN ID range. A simple demonstration of the QinQ access table is shown in Table 1.

TABLE 1

| Primary key | Control information |
|---|---|
| Prefix 1-mask 1 | Control information 1 |
| Prefix 2-mask 2 | Control information 2 |
| . . . | . . . |

In some embodiments, the primary key is formed by an external prefix-mask and an internal prefix-mask. In this case, the QinQ access table may be expressed as Table 2.

TABLE 2

| | |
|---|---|
| Primary key | Control information |

| | | |
|---|---|---|
| External prefix | Internal prefix | Control information 1 |
| 1-mask 1 | 1-mask 1 | |
| External prefix | Internal prefix | Control information 2 |
| 2-mask 2 | 2-mask 2 | |
| . . . | . . . | . . . |

Moreover, in some specific applications, the QinQ access table may further include prefixes-masks, address information or address indexes associated with control information, and control information. In this case, primary key values and the control information may be stored separately. For example, the primary key values and the address information or address indexes associated with control information are stored together in, for example, a ternary content addressable memory (TACM), and the control information is stored in a common memory. After a prefix-mask matching with a keyword is obtained by using the keyword, address information or an address index associated with control information is obtained, and corresponding control information can be obtained through the address information or address indexes associated with control information stored in the TCAM.

In the QinQ access table, each prefix-mask may be saved in a (prefix-mask) ordered pair. It is assumed that the length of a keyword is W, and thus the prefix and mask each occupies W bits. For an entry with a prefix length of Y (1≦Y≦W), the first Y bits of the prefix represent the value of the prefix, and the following W-Y bits of the prefix may be ‘0’ or ‘1’; the preceding Y bits of the mask are ‘1’, and mask bits of the mask, that is, the last W-Y bits are ‘0’. For example, in the situation that the number of bits W occupied by a prefix and mask is 6, it is assumed that a prefix-mask is 10XXXX. In this case, the length of the prefix is Y=2, and then the prefix-mask may be represented in an ordered pair (100000-110000). It is determined whether “keyword Bitwise And mask” is equal to “prefix Bitwise And mask” in mask matching and search of an entry. If “keyword Bitwise And mask” is equal to “prefix Bitwise And mask”, it indicates that the keyword matches with the entry; if “keyword Bitwise And mask” is not equal to “prefix Bitwise And mask”, it indicates that the keyword does not match with the entry. “Bitwise And” indicates bitwise and.

Definitely, it should be understood that, the preceding Y bits of the mask may also be represented by ‘0’, and accordingly, the mask bits of the mask may be represented by ‘1’. In this case, it is determined whether “keyword Bitwise OR mask” is equal to “prefix Bitwise OR mask” in the mask matching and search of an entry. If “keyword Bitwise OR mask” is equal to “prefix Bitwise OR mask”, it indicates that the keyword matches with the entry; if “keyword Bitwise OR mask” is not equal to “prefix Bitwise OR mask”, it indicates that the keyword does not match with the entry. “Bitwise OR” indicates bitwise or.

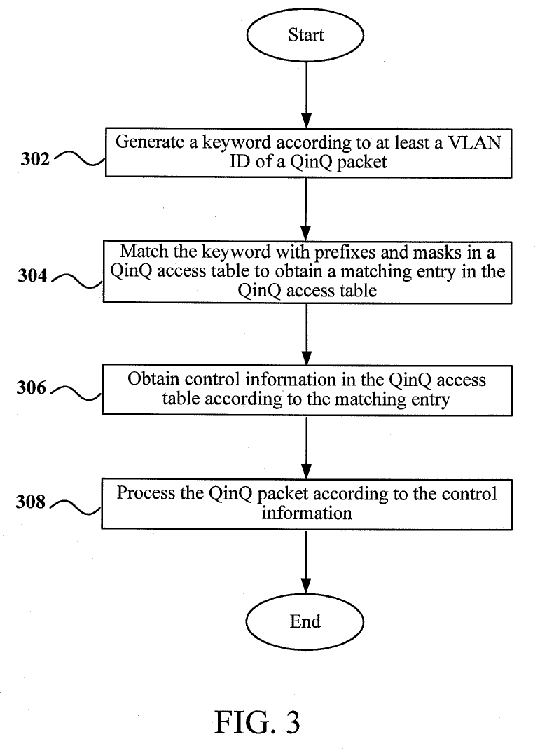

FIG. 3 is a flow chart of a method for processing QinQ packet according to an embodiment of the present invention. Reference is made to FIG. 3.

In S302, a keyword is generated according to at least a VLAN ID of a QinQ packet.

In some embodiments, the keyword may be generated according to a port ID, an external VLAN ID, and an internal VLAN ID of the QinQ packet. In some embodiments, the keyword may also be generated according to the port ID and the external VLAN ID of the QinQ packet, or the keyword may be generated according to the external VLAN ID and the internal VLAN ID of the QinQ packet.

A specific implementation of generating a keyword is introduced in detail by taking generation of the keyword according to a port ID, an external VLAN ID, and an internal VLAN ID of the QinQ packet as an example. For the convenience of illustration, it is assumed that the port ID is 5, the external VLAN ID is 27, and the internal VLAN ID is 130 in the QinQ packet. In this specific implementation, the port ID, the external VLAN ID, and the internal VLAN ID of the QinQ packet are respectively converted into a binary format, namely, 101, 11011, and 10000010. The obtained binary numbers are joined in order and combined together to obtain 10111011 10000010, namely, the corresponding keyword.

It should be understood that, in this specific implementation, the port ID, the external VLAN ID, and the internal VLAN ID in the QinQ packet are separately converted into a binary format and then joined in order to form the corresponding keyword. Definitely, the method for generating the keyword is not limited to this specific implementation. The method according to the embodiment of the present invention can be realized no matter what the specific implementation of generating the keyword is.

In S304, the keyword is matched with prefixes-masks in a QinQ access table to obtain a matching entry in the QinQ access table.

In this embodiment, the QinQ access table may be in the form shown in Table 1 in the preceding text. In this case, a bitwise operation is performed on the keyword and the prefix-mask in each entry of the QinQ access table separately. For example, when mask bits of a mask are represented by ‘0’, it is determined whether “keyword Bitwise AND mask” is equal to “prefix Bitwise AND mask” for each entry. If “keyword Bitwise AND mask” is equal to “prefix

Bitwise AND mask”, it indicates that the keyword matches with the entry; if “keyword Bitwise AND mask” is not equal to “prefix Bitwise AND mask”, it indicates that the keyword does not match with the entry.

In S306, control information in the matching entry is obtained according to the matching entry.

In S308, the QinQ packet is processed according to the obtained control information.

In this embodiment, the control information may be QinQ packet termination information or forwarding information required for subsequent forwarding of the QinQ packet, for example, forwarding information required for Layer 2 forwarding and MPLS forwarding.

Definitely, as can be known from the foregoing introduction, in the QinQ access table, when prefixes-masks and control information are stored in the same memory, corresponding control information can be obtained directly after the keyword is matched with the prefixes-masks in the QinQ access table to obtain a matching entry in the QinQ access table. When the prefixes-masks are stored together with address information or address indexes associated with control information, corresponding control information needs to be obtained according to the address information or address indexes associated with control information after the keyword is matched with the prefixes-masks in the QinQ access table to obtain a matching entry in the QinQ access table.

After the control information is obtained, the QinQ packet can be processed correspondingly. For example, QinQ termination is performed according to packet termination information, and the QinQ packet is forwarded according to forwarding information.

In the above S304, the matching of the keyword with prefixes-masks in the QinQ access table may be performed by special hardware, for example, a TCAM chip, a combination of software and hardware, or pure software.

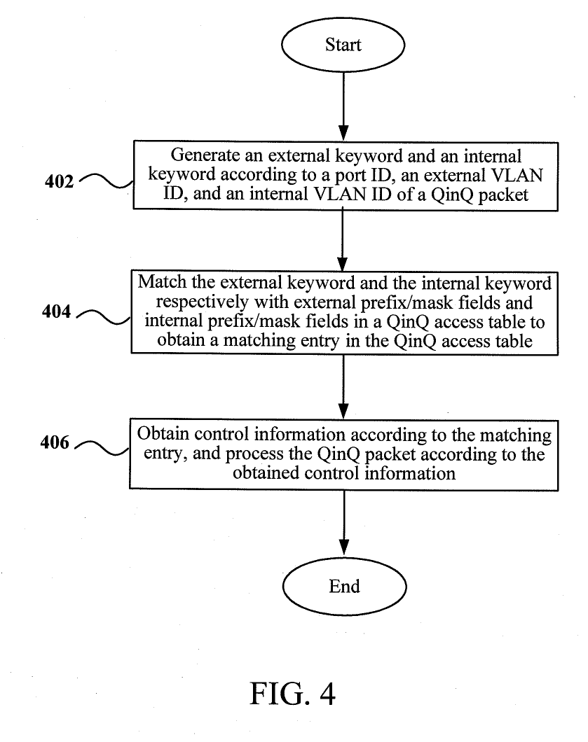

FIG. 4 is a flow chart of a method for processing QinQ packet according to another embodiment of the present invention. Reference is made to FIG. 4.

In S402, an external keyword and an internal keyword are generated according to a port ID, an external VLAN ID, and an internal VLAN ID of a QinQ packet.

In this embodiment, the external keyword may be generated according to the port ID and the external VLAN ID together, and the internal VLAN ID may be used as the internal keyword.

Specifically, similar to the previous embodiment, a binary representation of the port ID and a binary representation of the external VLAN ID may be joined together to generate the external keyword, which is not described herein again.

In S404, the external keyword and the internal keyword are respectively matched with external prefixes-masks and internal prefixes-masks in a QinQ access table to obtain a matching entry in the QinQ access table.

In this embodiment, the QinQ access table may be in the form shown in Table 2 in the preceding text. In this case, if the external keyword matches with an external prefix-mask in the QinQ access table and the internal keyword matches with an internal prefix-mask in the QinQ access table, the keyword matches with the entry.

In S406, control information is obtained according to the matching entry, and the QinQ packet is processed according to the obtained control information.

Similar to the previous embodiment, in the QinQ access table, when prefixes-masks and control information are stored in the same memory, corresponding control information can be obtained directly after the keyword is matched with the prefixes-masks in the QinQ access table to obtain a matching entry in the QinQ access table. When the prefixes-masks are stored together with address information or address indexes associated with control information, corresponding control information needs to be obtained according to the address information or address indexes associated with control information after the keyword is matched with the prefixes-masks in the QinQ access table to obtain a matching entry in the QinQ access table.

The QinQ access table in the embodiment of the present invention needs to be pre-configured before use. The pre-configuration includes generating prefixes-masks in the QinQ access table according to a user configured VLAN ID range, and generating control information in the QinQ access table according to service configuration of a network administrator.

The generation of the prefixes-masks in the QinQ access table according to the user configured VLAN ID range is introduced below. In the following description, mask bits in masks are represented by ‘1’ or ‘X’.

One method is to aggregate the VLAN ID range into one or more prefixes-masks by a user.

For the convenience of description, it is assumed that the user configured VLAN ID range is 24-28, and the following process is performed.

1) VLAN IDs in the configured VLAN ID range are all converted into binary representations, as shown in Table 3.

2) The binary representations of the VLAN IDs are arranged in order.

3) A largest continuous segment is selected from the arrangement to determine a numerical value n. The numerical value n satisfies the following condition: low-order n bits of binary representations of all digits in the continuous segment are extracted to form a collection which exactly includes all permutations and combinations of n-bit binary numbers.

Taking Table 3 as an example, low-order 2 bits of binary representations of a continuous segment 24-27 in the binary representations of the VLAN IDs are extracted to form a collection {00, 01, 10, 11} which exactly includes all permutations and combinations of 2-bit binary numbers, so that in the situation shown in Table 3, the numerical value satisfying the condition is n=2.

4) After the numerical value n is determined, the continuous segment can be aggregated into a prefix-mask. Low-order n bits of the prefix-mask are mask bits which are set to 1.

5) In the continuous segment of binary representation, the first several bits are the same except the low-order n bits. The same bits are the prefix of the prefix-mask.

Still taking Table 3 as an example, because n=2, the last 2 bits are mask bits, namely, 11. Except the last 2 bits, binary representations of 24-27 are the same in the first 3 bits, that is, all being 110. As a result, the prefix is 11000. Therefore, 24-27 can be aggregated into a prefix-mask, namely, (11000-00011), that is, (24-3), while 28 forms a prefix-mask (28-0) alone, in which the mask of 0 indicates that the mask has no mask bits.

TABLE 3

| Decimal | Binary |
|---|---|
| 24 | 11000 |
| 25 | 11001 |
| 26 | 11010 |
| 27 | 11011 |
| 28 | 11100 |

Another method is to convert the configured VLAN ID range into one or more prefix-mask aggregated segments automatically.

It is assumed that the user configured VLAN ID range is represented as Rmin-Rmax and W is the number of bits occupied by a prefix-mask. The corresponding prefix-mask can be obtained through the following codes:

Range_convert_Prefix (Rmin, Rmax, Prefix[ ], Mask[ ])
{

```
int d=0, i;
while (Rmin<Rmax){
for (i=0; i<W; i++)
  if (((Rmin is not exactly divisible by 2ⁱ⁺¹) or
  (Rmin+2ⁱ⁺¹−1)>Rmax) break;
Mask[d]=2ⁱ−1;
Prefix[d]=Rmin;
d=d+1;
Rmin=Rmin+2ⁱ;
```

}

Still taking the range of user VLAN IDs of 24-28 as an example, in the situation that W adopts a value of 5, Prefix[0]=24, Mask[0]=3; and Prefix[1]=28, Mask[1]=0 are derive calculation, so as to obtain two prefixes-masks (24-3) and (28-0), namely, 110XX and 11100.

In the above methods, the user only needs to configure ranges of VLAN IDs requiring to be supported by the QinQ without sensing such aggregation conversion, and the equipment automatically aggregates the VLAN ID ranges into prefixes-masks and manages QinQ entry resources according to the aggregated prefixes-masks, which is transparent to the user.

It should be pointed out that, although the circumstance that a continuous VLAN ID range configured by the user is aggregated into one or more prefixes-masks in the above embodiments, the method according to the embodiments of the present invention is also applicable to the circumstance that multiple discontinuous VLAN ID ranges configured by the user are aggregated into one or more prefixes-masks.

For example, user configured VLAN ID ranges are 24 and 26-27 which are discontinuous and VLAN ID 25 is not occupied by other users, so that the discontinuous VLAN ID ranges of the user may be merged into 24-27 and represented by an entry with a prefix-mask of (24-3) in the QinQ access table if the merging does not increase entries in the QinQ access table.

In some other embodiments of the present invention, even if VLAN IDs between discontinuous VLAN ID ranges of a user are occupied by other users, the discontinuous VLAN ID ranges of the user may also be merged. For example, VLAN ID ranges of a first user include 24 and 26-27 and a VLAN ID range of a second user is 25. In this case, the VLAN ID ranges 24 and 26-27 of the first user may be merged into 24-27. Thereby, a prefix-mask of a corresponding entry in the QinQ access table of the first user is (24-3) or 110XX, while a prefix-mask of a corresponding entry in the QinQ access table of the second user is (25-0) (herein, a mask of 0 indicates that the mask has no mask bits) or 11001. When 24, 26, and 27 are used as keywords and matched with prefixes-masks in the QinQ access table, only the entry with the prefix-mask of (24-3) matches; and when 25 is used as the keyword and matched with prefixes-masks in the QinQ access table, the two entries with the prefixes-masks of (24-3) and (25-0) both match.

When such situation arises, it may be solved by longest prefix matching. That is, the QinQ packet processing method provided in the embodiments of the present invention may further include: selecting an entry corresponding to a prefix-mask having the longest prefix from multiple matching prefixes-masks as a matching entry when the multiple matching prefixes-masks exist. For example, in the situation that the matching prefixes-masks are (24-3) and (25-0), mask bits of (24-3) occupy 2 bits, so the prefix length is W−2=5−2=3; while mask bits of (25-0) occupy 0 bit, so the prefix length is W−0=5−0=5, and thus an entry corresponding to the prefix-mask (25-0) with a prefix length of 5 is selected.

An application example of the QinQ packet processing method according to the embodiments of the present invention is introduced below.

It is assumed that a user configures a range of external VLAN IDs of 24-28, a range of internal VLAN IDs of 100-150, and a port number occupying 4 bits on a port 5.

According to the method for processing QinQ packet in the embodiments of the present invention, first, prefix-mask aggregation is performed on the VLAN ID range configured by the user. In either of the above two methods of generating prefixes-masks in a QinQ access table according to a user configured VLAN ID range, the external VLAN IDs are aggregated into two prefixes-masks (24-3) (namely, 0000000110XX) and (28-0) (namely, 000000011100), and the internal VLAN IDs are aggregated into 8 prefixes-masks (100-3) (namely, 0000011001XX), (104-3) (namely, 0000011010XX), (108-3) (namely, 0000011011XX), (112-15) (namely, 00000111XXXX), (128-15) (namely, 00001000XXXX), (144-3) (namely, 0000100100XX), (148-1) (namely, 00001001010X), and (150-0) (namely, 000010010110).

Then, an external prefix-mask is generated according to the port ID and the prefixes-masks of the external VLAN IDs, for example, formed by joining a binary representation of the port ID and the binary representations of the prefixes-masks formed by aggregating the external VLAN IDs together, and an internal prefix-mask is generated according to the prefixes-masks of the internal VLAN IDs. As a result, in this application, the user of the port occupies 2×8=16 entries in the QinQ access table. The specific entries occupied by the port 5 in the QinQ access table are shown in the following Table 4.

TABLE 4

Primary key

| External prefix-mask | Internal prefix-mask | Control information address |
|---|---|---|
| 0101 0000000110XX | 0000011001XX | Control information address 1 |
| 0101 0000000110XX | 0000011010XX | Control information address 2 |
| 0101 0000000110XX | 0000011011XX | Control information address 3 |
| 0101 0000000110XX | 00000111XXXX | Control information address 4 |
| 0101 0000000110XX | 00001000XXXX | Control information address 5 |
| 0101 0000000110XX | 0000100100XX | Control information address 6 |
| 0101 0000000110XX | 00001001010X | Control information address 7 |
| 0101 0000000110XX | 000010010110 | Control information address 8 |
| 0101 000000011100 | 0000011001XX | Control information address 9 |
| 0101 000000011100 | 0000011010XX | Control information address 10 |
| 0101 000000011100 | 0000011011XX | Control information address 11 |
| 0101 000000011100 | 00000111XXXX | Control information address 12 |
| 0101 000000011100 | 00001000XXXX | Control information address 13 |
| 0101 000000011100 | 0000100100XX | Control information address 14 |
| 0101 000000011100 | 00001001010X | Control information address 15 |
| 0101 000000011100 | 000010010110 | Control information address 16 |

‘X’ bits in the prefixes-masks are mask bits.

After receiving a QinQ packet, the port obtains a port ID 5, an external VLAN ID (assumed to be 27), and an internal VLAN ID (assumed to be 130) of the QinQ packet; generates an external keyword 0101000000011011 according to the port ID and the external VLAN ID, and generates an internal keyword 000010000010 according to the internal VLAN ID, in which the external keyword occupies 4+12=16 bits and the internal keyword occupies 12 bits; matches the external keyword and the internal keyword correspondingly with the external prefixes-masks and internal prefixes-masks in the QinQ access table, and finds the following matching entry:

| | | |
|---|---|---|
| 01010000000110XX | 00001000XXXX | Control information address 5 |

and then obtains corresponding control information according to the control information address 5 in the matching entry, and processes the QinQ packet according to the control information.

In the method for processing QinQ packet provided in the embodiments of the present invention, a user configured VLAN ID range is aggregated into prefixes-masks in advance, and corresponding QinQ access table entries are generated. When a QinQ packet is received, a search keyword is generated and matched with the prefixes-masks in the QinQ access table entries, corresponding control information is obtained, and the packet is processed, so as to expand the number of VLAN IDs actually supported by the QinQ access table.

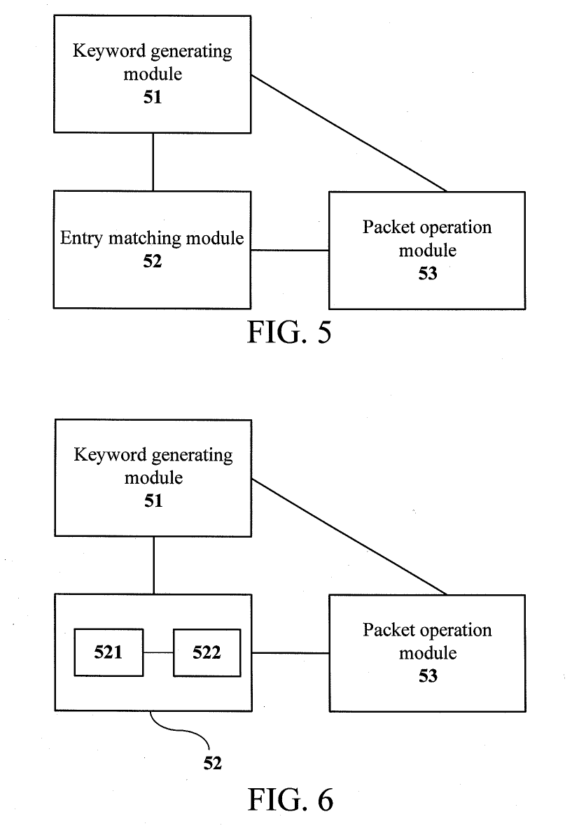

FIG. 5 is a structural view of a device for processing QinQ packet according to an embodiment of the present invention. As shown in FIG. 5, the device for processing packet includes a keyword generating module 51, an entry matching module 52, and a packet operation module 53.

The keyword generating module 51 is adapted to generate a keyword according to at least a VLAN ID of a QinQ packet, and send the generated keyword to the entry matching module 52. For example, the keyword is generated according to a port ID, an external VLAN ID, and an internal VLAN ID of the QinQ packet; or, the keyword is generated according to the port ID and the external VLAN ID of the QinQ packet; or, the keyword is generated according to the external VLAN ID and the internal VLAN ID of the QinQ packet.

The entry matching module 52 is adapted to receive the keyword from the keyword generating module 51, match the keyword with prefixes-masks in a QinQ access table to obtain a matching entry in the QinQ access table, and obtain control information according to the matching entry and send the control information to the packet operation module 53. For example, the entry matching module 52 may directly obtain the control information of the corresponding entry according to the matching prefix-mask, or first obtain address information or an address index associated with control information according to the matching prefix-mask and then obtain the corresponding control information according to the address information or address index.

The packet operation module 53 is adapted to receive the control information from the entry matching module 52 and process the QinQ packet according to the control information.

In the device for processing QinQ packet provided in the embodiment of the present invention, because VLAN IDs are aggregated, entries in the QinQ access table are reduced, which actually expands the VLAN ID range supported by the QinQ access table.

In some embodiments of the device for processing QinQ packet in the present invention, the entry matching module 52 may include a keyword matching unit 521 and a control information acquiring unit 522, as shown in FIG. 6.

The keyword matching unit 521 is adapted to match the keyword with the prefixes-masks in the QinQ access table to obtain the matching entry in the QinQ access table. For example, the keyword matching unit 521 may be implemented by a TCAM or fully associative memory adapted to store and search for prefixes-masks in the QinQ access table. The TCAM or fully associative memory is capable of accomplishing keyword matching and search in a hardware clock period. The TCAM can match and compare a keyword with all entries in the TCAM as long as the content of the keyword is entered, and finally returns an address corresponding to the matching entry in the TCAM.

The control information acquiring unit 522 is adapted to obtain the control information according to the matching entry obtained by the keyword matching unit 521.

In some other embodiments of the device for processing QinQ packet in the present invention, the keyword matching unit 521 may further be implemented by a chip for longest prefix matching.

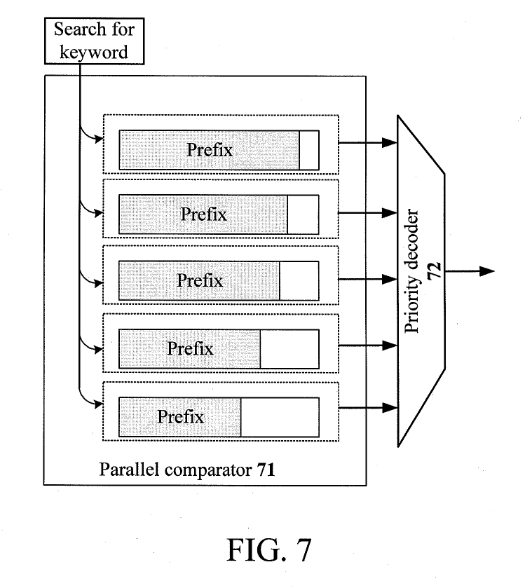

FIG. 7 is a schematic structural view of a chip for longest prefix matching. As shown in FIG. 7, the chip includes a parallel comparator 71 and a priority decoder 72.

The parallel comparator 71 is adapted to receive the keyword, compare the keyword with all the prefix-masks in parallel, and output all matching item addresses to the priority decoder 72.

The priority decoder 72 is adapted to receive the matching item addresses, and select a matching prefix-mask according to the matching item addresses. For example, the priority decoder 72 may select an address from the received matching item addresses, and the address is corresponding to a prefix-mask with the longest prefix.

Thereby, the control information acquiring unit 522 can obtain the control information of the corresponding entry according to a result output from the longest prefix matching chip.

Furthermore, the parallel comparator is further adapted to store the prefixes-masks according to prefix lengths. For example, the parallel comparator 71 may arrange the prefixes-masks from lower addresses to higher addresses according to prefix lengths, that is, the longer the prefix is, the lower the address for storing the prefix-mask is. Alternatively, the parallel comparator 71 may also arrange the prefixes-masks from higher addresses to lower addresses according to prefix lengths, that is, the longer the prefix is, the higher the address for storing the prefix-mask is, and the priority decoder 72 selects a highest address from the received matching addresses, which may also realize longest prefix matching.

The device for processing QinQ packet provided in the embodiments of the present invention not only expands the VLAN ID range supported by the QinQ access table, but also realizes prefix-mask matching through hardware, thereby enhancing the system efficiency.

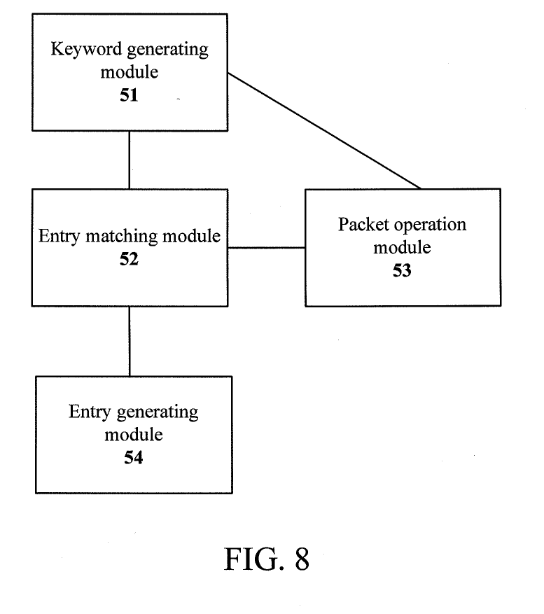

In another embodiment of the present invention, the device for processing QinQ packet may further include an access table generating module, as shown in FIG. 8. The access table generating module is adapted to generate a QinQ access table. An entry of the QinQ access table includes a prefix-mask and control information.

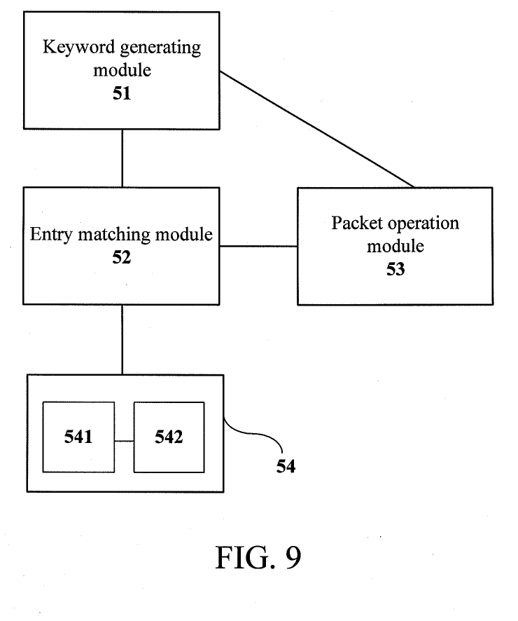

Specifically, as shown in FIG. 9, the access table generating module 54 may include a prefix-mask generating unit 541 and a control information generating unit 542.

The prefix-mask generating unit 541 is adapted to generate prefixes-masks according to a user configured VLAN ID range.

The control information generating unit 542 is adapted to generate control information according to service configuration of a network administrator.

The device for processing QinQ packet provided in the embodiments of the present invention not only expands the VLAN ID range supported by a QinQ access table, but also automatically generates a QinQ access table according to user configured VLAN IDs, thereby facilitating the user's management and use of the QinQ access table.

In a further embodiment of the device for processing QinQ packet in the present invention, entries of a QinQ access table include external prefixes-masks and internal prefixes-masks.

The keyword generating module 51 is adapted to generate an external keyword according to a port ID and an external VLAN ID of the QinQ packet, generate an internal keyword according to an internal VLAN ID, and send the generated external keyword and internal keyword to the entry matching module 52.

The entry matching module 52 is adapted to receive the external keyword and the internal keyword from the keyword generating module, and match the external keyword and the internal keyword correspondingly with the external prefixes-masks and the internal prefixes-masks in the QinQ access table to obtain a matching entry in the QinQ access table. For example, the entry matching module 52 may implement matching through a structure of a secondary TCAM chip.

In the device for processing QinQ packet provided in the embodiments of the present invention, because VLAN IDs are aggregated, entries in a QinQ access table are reduced, which actually expands a VLAN ID range supported by the QinQ access table.

Persons skilled in the art should understand that, various modules included in the QinQ packet processing device according to the embodiments of the present invention may be implemented through special hardware, through software by using a common CPU and memory, or through a combination of software and hardware.

The embodiments of the present invention are provided for the sake of exemplification and description, but are not exhaustive or intended to limit the present invention to the disclosed form. Many modifications and variations are obvious to persons of ordinary skill in the art. The embodiments are selected and described for illustrating the principle and actual application of the present invention in a better way, and enabling persons of ordinary skill in the art to understand the invention and design various embodiments for specific purposes with various modifications.

1. A method for processing a 802.1Q in 802.1Q (QinQ) packet, comprising:
generating a keyword according to at least a virtual local area network identification (VLAN ID) of a QinQ packet;
matching the keyword with a prefix-mask in a QinQ access table to obtain a matching entry in the QinQ access table;
obtaining control information in the QinQ access table according to the matching entry; and
processing the QinQ packet according to the control information.

2. The method for processing the QinQ packet according to claim 1, wherein
the generating the keyword according to at least the VLAN ID of the QinQ packet comprises:
generating the keyword according to a port ID and an external VLAN ID of the QinQ packet;
generating the keyword according to the external VLAN ID and an internal VLAN ID of the QinQ packet; or
generating the keyword according to the port ID, the external VLAN ID, and the internal VLAN ID of the QinQ packet.

3. The method for processing the QinQ packet according to claim 1, wherein the prefix-mask comprise an external prefix-mask and an internal prefix-mask,
wherein the generating the keyword according to at least the VLAN ID of the QinQ packet comprises:
generating an external keyword according to a port ID and an external VLAN ID of the QinQ packet; and
generating an internal keyword according to an internal VLAN ID of the QinQ packet; and,
wherein the matching the keyword with the prefix-mask in the QinQ access table comprises:
matching the external keyword and the internal keyword respectively with the external prefix-mask and the internal prefix-mask in the QinQ access table.

4. The method for processing the QinQ packet according to claim 1, wherein the keyword is matched with the prefix-mask in the QinQ access table by using a ternary content addressable memory (TCAM); or
when the prefix-mask includes an external prefix-mask and an internal prefix-mask, an external keyword and an internal keyword are matched with the external prefix-mask and the internal prefix-mask, respectively, in the QinQ access table by using a secondary TCAM.

5. The method for processing the QinQ packet according to claim 4, wherein when multiple matching prefixes-masks exist, the matching the keyword with the prefix-mask in the QinQ access table to obtain the matching entry in the QinQ access table comprises:
matching the keyword with the prefix-mask in the QinQ access table; and
selecting an entry corresponding to the prefix-mask with a longest prefix from multiple matching prefixes-masks as the matching entry.

6. The method for processing the QinQ packet according to claim 1, wherein the control information of the matching entry is next hop information, and the processing the QinQ packet according to the control information of the matching entry is forwarding the QinQ packet; or
the control information of the matching entry is QinQ packet termination information, and the processing the QinQ packet according to the control information of the matching entry is terminating the QinQ packet.

7. The method for processing the QinQ packet according to claim 1, further comprising:
generating the prefix-mask in the QinQ access table according to a user configured VLAN ID range in advance of matching the keyword with the prefix-mask.

8. A device for processing a 802.1Q in 802.1Q (QinQ) packet, comprising:
a keyword generating module adapted to generate a keyword according to at least a virtual local area network identification (VLAN ID) of a QinQ packet and send the keyword;
an entry matching module adapted to receive the keyword from the keyword generating module, match the keyword with a prefix-mask in a QinQ access table to obtain a matching entry in the QinQ access table, and obtain control information according to the matching entry and send the control information; and
a packet operation module adapted to receive the control information from the entry matching module and process the QinQ packet according to the control information.

9. The device for processing the QinQ packet according to claim 8, wherein:
the keyword generating module generates the keyword according a port ID and an external VLAN ID of the QinQ packet;
generates the keyword according to the external VLAN ID and an internal VLAN ID of the QinQ packet; or
generates the keyword according to the port ID, the external VLAN ID, and the internal VLAN ID of the QinQ packet.

10. The device for processing the QinQ packet according to claim 8, wherein:
the keyword generating module is adapted to generate an external keyword according to a port ID and an external VLAN ID of the QinQ packet, generate an internal keyword according to an internal VLAN ID, and send the external keyword and the internal keyword; and
the entry matching module is adapted to receive the external keyword and the internal keyword from the keyword generating module and match the external keyword and the internal keyword with an external prefix-mask and an internal prefix-mask, respectively, in the QinQ access table to obtain the matching entry in the QinQ access table.

11. The device for processing the QinQ packet according to claim 8, wherein the entry matching module comprises:
a keyword matching unit adapted to match the keyword with the prefix-mask in the QinQ access table to obtain the matching entry in the QinQ access table; and
a control information acquiring unit adapted to obtain the control information according to the matching entry obtained by the keyword matching unit.

12. The device for processing the QinQ packet according to claim 11, wherein the keyword matching unit is a ternary content addressable memory (TCAM) chip, a secondary TCAM chip, or a longest prefix matching chip,
wherein when the keyword matching unit is the longest prefix matching chip, the keyword matching unit comprises:
a parallel comparator adapted to receive the keyword, compare the keyword with the prefix-mask in parallel, and output all matching item addresses to a priority decoder,
the priority decoder being adapted to receive the matching item addresses and select a matching prefix-mask according to the matching item addresses.

13. The device for processing the QinQ packet according to claim 12, wherein the parallel comparator is further adapted to store the prefix-mask according to prefix lengths.

14. The device for processing the QinQ packet according to claim 8, wherein the device further comprises an access table generating module adapted to generate the QinQ access table, wherein entries of the QinQ access table include a prefix-mask and control information.

15. The device for processing the QinQ packet according to claim 8, wherein the control information of the matching entry is next hop information and the packet operation module forwards the QinQ packet; or
the control information of the matching entry is QinQ packet termination information and the packet operation module performs QinQ termination on the QinQ packet.
